(19) United States
(12) Patent Application Publication
(10) Pub. No.: US 2023/0257316 A1
(43) Pub. Date: Aug. 17, 2023

(54) LIQUID SUSPENSION COMPOSITIONS AND COATED FERTILIZER PARTICLES

(71) Applicant: Keystone Specialty Chemicals LLC, Hillsborough, NJ (US)

(72) Inventors: Leahann Iannotta, Wayne, PA (US); Rajesh Pazhianur, Belle Mead, NJ (US)

(21) Appl. No.: 18/140,405

(22) Filed: Apr. 27, 2023

Related U.S. Application Data
(63) Continuation-in-part of application No. 18/032,658, filed on Jan. 1, 0001.
(60) Provisional application No. 63/093,917, filed on Oct. 20, 2020.

(51) Int. Cl. C05D 5/00; C05G 3/90; C05G 5/23

(52) U.S. Cl. CPC C05D 5/00; C05G 3/90; C05G 5/23

(57) ABSTRACT

Described are coating compositions, e.g., suspensions, that contain suspended (non-dissolved) micronutrient particles and a water-miscible liquid carrier that contains water and water-miscible organic liquid, for applying the micronutrient particles to solid fertilizer particles, related methods of preparing and using the coating compositions, and solid fertilizer particles that contain the coating compositions.

### PRIORITY

This application is a continuation-in-part of U.S. patent application Ser. No. 18/032,658, filed Apr. 19, 2023, which claims the benefit from International Applicant No. PCT/US2021/055554, filed Oct. 19, 2021, which claims priority to U.S. Provisional Application No. 63/093,917, filed Oct. 20, 2020, entitled “LIQUID SUSPENSION COMPOSITIONS AND COATED FERTILIZER PARTICLES”, all of which are incorporated herein by reference in their entireties, for all purposes.

### FIELD

The following describes coating compositions that contain micronutrients suspended in a liquid medium, and methods of preparing and using the coating compositions.

### BACKGROUND

For agricultural applications, a common form of fertilizer is that of inorganic particulate solids. These particulate solids, commonly in the form of pellets or granules, typically are introduced to soil to provide growing plants with a substantial amount of required macronutrients and often secondary nutrients.

Regarding micronutrients, soil application is the most common method of application, with recommended application amounts usually being less than about 1.1 g/m² (10 lb./acre) on an elemental basis. This very low application rate for micronutrients makes separate, stand-alone application of a micronutrient essentially impossible, and favors the idea of applying micronutrients in combination with a macronutrient fertilizer. Desirably, commercial fertilizer products may contain one or more micronutrients combined with solid fertilizer particles that contain macronutrient, and the solid particles that contain micronutrient and macronutrient are applied in a single application. Combining micronutrients with the solid particle macronutrients permits uniform distribution of the micronutrients without the need for special equipment or multiple application steps.

Accordingly, the fertilizer industry desires particulate solid-type fertilizer products that include micronutrients combined with macronutrients. While there would seem to be various possible modes of combining a micronutrient with a macronutrient-containing fertilizer, each mode is considered to exhibit potential disadvantages. Physically blending a solid micronutrient component (e.g., as solid particles) with solid particulate fertilizer particles (pellets or granules) can produce a fertilizer composition that contains different particles having substantially different particle sizes and densities, which can lead to particles becoming segregated during storage and handling, which can in turn result in uneven application. Also, particularly where powdered micronutrients are used, dusting can occur during transfer and application.

A different option for combining a micronutrient with a macronutrient fertilizer is by coating a micronutrient onto an exterior of a solid macronutrient fertilizer particulate. This has proven to be not a trivial task, however, based on numerous technical challenges. Various coating techniques are described in International Patent Publication Nos. WO 1999/015480, WO 2003/071855, and WO 2011/080764, U.S. Pat. Nos. 3,692,529, 4,657,576, 7,497,891, 9,199,883, and 9,540,291, and U.S. Patent Publ. No. 2005/0076687, as well as others.

U.S. Pat. Nos. 9,994,492 and 10,118,867 describe methods for preparing micronutrient-coated solid fertilizer particulates, with the resulting solid particulates being described as free-flowing and non-dusting. Methods involve a single application of a suspension that contains one or more micronutrient materials onto solid fertilizer particulates. The suspension is described as containing the micronutrient suspended in “any suitable natural, mineral or synthetic oil,” with vegetable oil being described as providing better dispersions than mineral oil.

Working with an oil as a liquid carrier to suspend solid micronutrient particles presents significant practical challenges, however. Oil-based micronutrient suspensions tend to be relatively viscous, especially at lower temperatures commonly found in the late winter and early spring, when these products are combined with fertilizer particles. Moreover, oils, not typically being water-miscible, can be difficult to clean from surfaces of equipment that is used to combine the suspension with fertilizer particles. In specific, equipment such as pumps, hosing, conduits, blenders, valves, nozzles, etc., are used to apply an oil-based micronutrient suspension to solid fertilizer particles. Due to the high concentration of oil in the suspension, cleaning the oil-based micronutrient suspension from surfaces of this type of equipment can be costly and time consuming. Also, a suspension must be stable over time, during transport and storage of the suspension. Micronutrients contain metals such as zinc, iron, boron, copper, and others, which having a density that is substantially greater than organic solids, may be more prone to settling out of a suspension.

### SUMMARY

In view of the challenges involved in using oil-based micronutrient suspension products, including difficulties during applying oil-based micronutrients contained in a suspension onto fertilizer particles, especially at lower temperatures, and subsequent cleaning of equipment that is used to apply the oil-based suspensions, the Applicant has identified a need in the fertilizer industry for alternatives to oil-based micronutrient suspension products.

A preferred alternative may be in the form of a suspension that contains one or more types of suspended solid micronutrient particles in a liquid carrier that contains a reduced amount of water-immiscible oil or other immiscible ingredients. Useful or preferred such suspensions can contain a liquid carrier that is water-miscible. The liquid carrier can include water and one or more water-miscible, non-oil, organic liquids. The liquid carrier can contain a substantial (majority) amount of water in combination with an amount of water-miscible organic liquid. A liquid carrier may alternately contain a substantial (majority) portion of organic liquid or may contain substantially entirely water-miscible organic liquid as.

Water-miscible organic liquids can include organic liquids commonly used as organic solvents, organic materials commonly used as surface active agents (e.g., surfactants, emulsifiers, dispersing agents, suspending agents, and the like), thickeners or suspending agents such as particle or polymers (rheological or viscosity-control agents), and other water miscible organic materials such as adjuvants that may be useful in a coating composition as described.

As Applicant has discovered, suspensions that are made to include water-miscible liquid carrier may also, advantageously, be formulated to contain a useful or high concentration of suspended solid micronutrient particles (optionally in combination with biostimulant, urease inhibitor (e.g., NBPT), and nitrification inhibitor (e.g., DCD), or a combination of these), to allow for efficient application of a desired amount (concentration) of the micronutrient particles and optional biostimulant, urease inhibitor, nitrification inhibitor, onto a solid fertilizer. Additionally, such suspensions may be formulated to be storage stable, as well as flowable at ambient temperatures that may occur during late winter and spring, including at northern locations that experience low ambient temperatures (e.g., below 50, 40, or 30 degrees Fahrenheit) during those seasons. And, such suspensions may be formulated to contain water-miscible liquid ingredients that allow the suspension to be efficiently cleaned from equipment that is used to store, handle, or apply the suspension to solid fertilizer, by rinsing the equipment with water that does not require added cleaning agent.

Example micronutrient suspension products can contain a reduced amount of water-immiscible oil relative to previous comparable suspensions, or, preferably, may contain substantially no water-immiscible oil (or other water-immiscible ingredients) as part of a liquid carrier for the suspension. Example micronutrient suspensions may instead contain a liquid carrier that includes (comprises, consists of, or consists essentially of) water in combination with one or more water-miscible organic liquids, with a low amount or no amount of water-immiscible ingredients such as oil. The liquid carrier generally, and the organic liquid more specifically, can preferably be water-miscible, and of a type that is efficiently removable from a surface using untreated water, meaning water that does not contain added cleaning agent, to leave an insubstantial amount of residue. Particularly useful liquid carriers and organic liquids contain (e.g., comprise, consist of, or consist essentially of) ingredients that are completely water-miscible.

Provided herein are coating compositions that contain micronutrients, solid fertilizer compositions (e.g., pellets, particles, prills, etc.) that include a coating composition that contains one or more micronutrients, and methods of applying a coating composition that contains micronutrient particles to solid fertilizer.

Preferred examples of the described coating compositions do not require and may be free from or substantially free from water-immiscible ingredients, particularly water-immiscible oil ingredients. Preferred examples of the described coating compositions also do not require and may specifically exclude a polymer material as part of a coating composition.

Preferred coating compositions can be applied to solid fertilizer particles to produce coated fertilizer particles that are free flowing, non-dusting particulate fertilizers with micronutrient-containing coatings provided at particles surfaces.

The coating composition can be a liquid suspension that contains an amount of micronutrient particles suspended in a liquid carrier. A useful or preferred suspension that contains water-miscible ingredients in a liquid carrier may exhibit one or more of the following: a relatively high concentration of the micronutrient particles in the suspension; stability of the suspension during storage and use, including resistance to settling or stratification of suspended, solid micronutrient particles, or (alternately) the ability to efficiently re-suspend particles of a suspension that may become stratified or that may contain settled solid micronutrient particles; stable flow properties to allow the suspension to be efficiently used at reduced ambient temperature (e.g., below 50, 40, or 30 degrees Fahrenheit); and the ability to be efficiently cleaned with untreated water from surfaces of equipment used to handle the suspension or to apply the suspension to solid fertilizer particles.

A coating or a coating composition (e.g., suspension) includes one or more types of micro-nutrient particles suspended in a liquid carrier that contains non-oil, water-miscible liquid carrier, and is applied to particles that contain macronutrient. A coating composition as described, to be useful for applying a coating that contains micronutrient onto fertilizer particles, may preferably be flowable, or “free flowable,” meaning the liquid composition is capable of being handled, pumped, stored, and used by applying the liquid composition to solid fertilizer particles using typical, standard, or commonly used or available equipment (sometimes referred to herein as “application equipment”), optionally including equipment that sprays the liquid composition onto surfaces of solid fertilizer particles, while agitating the particles to mix the particles and coating composition together. Preferred coating compositions have flow properties that allow the compositions to be applied to solid fertilizer particles using typical liquid handling equipment, at a relatively low temperature. These compositions have flow properties such as viscosity that allow the compositions to be flowed, pumped, sprayed, or otherwise handled by steps necessary to apply the liquid composition evenly to solid fertilizer particles at relatively low temperatures, such as at or below 50, 40, 35, or 30 degrees Fahrenheit.

Also preferably, a liquid coating composition of the present description can contain water-miscible liquid carrier to allow the coating composition to be effectively and efficiently cleaned from the equipment used for applying the liquid composition to solid fertilizer particles, including at relatively low temperatures as mentioned. Previous micronutrient suspensions that contain high amounts of water-immiscible oil as part of a liquid carrier can be difficult to clean from surfaces of such equipment. The oil, being immiscible with water, requires specialized cleaning steps and materials such as detergents, for the oil to be removed from surfaces of the equipment. The oil-based suspensions will not be removed from equipment surfaces using only water, without added cleaning agent.

For efficient use of a coating composition as described, to combine micronutrient with solid fertilizer particles in a desired relative amount of micronutrient to solid fertilizer, and with a relatively low or minimal amount of liquid carrier, a coating composition may preferably contain a high concentration of micronutrient particles. For example, a preferred coating composition may include up to or greater than 20, 30, 40, 50, or 60 percent by weight micronutrient particles based on total weight coating composition. Example coating compositions may also contain biostimulant, urease inhibitor (e.g., NBPT), nitrification inhibitor (e.g., DCD), or a combination of these.

Formulating a coating composition in the form of a suspension that contains a relatively high concentration of micronutrient particles, however, is challenging on multiple fronts. One challenge is stability of a suspension that contains a high concentration of suspended micronutrient particles. Micronutrients are metals, and micronutrient compounds contain metals. Metals are substantially more dense than organic materials. An initial challenge in producing a micronutrient-containing suspension is merely to cause a useful or high concentration of solid metal-containing micronutrient-containing particles to become suspended by a liquid carrier, with even short term stability. Typically, some type of co-ingredient is required to cause solid particles (micronutrients or otherwise) to become suspended in a liquid carrier, and to remain suspended within the liquid carrier. The co-ingredient (which may be a water-miscible organic liquid) may be, e.g., a dispersant, a wetting agent, a surfactant, a thickener, a suspending agent, one or a combination of which is effective to maintain separation of the particles suspended within the liquid medium, and to inhibit settling, sedimentation, or stratification of the particles within the liquid medium. Other co-ingredients may also be helpful, for example, to improve flow properties (including at low temperatures), or to facilitate processing or cleaning, such as surfactant, emulsifier, freezing point depressant, wetting agent, detergent, dye, or colorant. A goal of a high concentration of the micronutrient particles is made even more difficult by a high amount of the micronutrient particles causing a reduced amount of the formulation, on a percentage basis, from being available to include one or more of these co-ingredients.

For the present compositions, the Applicant has identified that useful or advantageous suspensions can be prepared to contain liquid carrier and suspended micronutrient particles, with water-miscible organic liquid and optional water used as the liquid carrier, and with a minimum amount of water-immiscible oil or substantially no water-immiscible oil as part of the liquid carrier. Preferred water-miscible liquid carriers made with water-immiscible organic liquids and optional water are capable of containing solid micronutrient particles suspended within the liquid carrier, without being dissolved, at relatively high concentrations, e.g., at least 20, 30, 40, 50, or 60 weight percent micronutrient particles based on total weight micronutrient particles and liquid carrier, e.g., based on total weight of a coating composition as described, or based on total weight coating composition.

A suspension (coating composition) as described, that contains micronutrient particles (preferably at a relatively high concentration) suspended in water-miscible liquid carrier can be prepared to contain these ingredients and other optional ingredients to form a uniform suspension that is stable over a short term time frame and also preferably over a longer term timeframe. Preferred suspensions are sufficiently stable to be prepared, stored, transported, and used (by application to solid fertilizer particles) efficiently and on a commercial basis. Examples of desired stability include the ability to be stored for weeks or months without flocculation or agglomeration of particles, without undue viscosity build, without solid particles settling to form sediment at a bottom of a container, and without stratification of a suspension, meaning settling of suspended micronutrient particles to cause a concentration gradient of the particles within a suspension without the particles forming sediment at the bottom of the container.

A coating composition may include an optional surfactant.

Alternatively or additionally, a coating composition may include an optional wetting agent, a dispersant, or both.

Alternatively or additionally, a coating composition may include one or more polymers, one or more of which optionally can be a chelating polymer.

Alternatively or additionally, a coating composition may include one or more adjuvants such as, but not limited to, a thickener, a suspension aid, an antifoaming agent, a freezing point depression, and a dye or colorant.

Micronutrient particles may be unmilled or milled, either wet or dry.

To assist in understanding the description which follows, the definitions set forth immediately below are intended to apply throughout unless the surrounding text explicitly indicates a contrary intention:
“macronutrient” means a compound that contains potassium (K), phosphorus (P), nitrogen (N), or two or more of these;
“secondary nutrient” means a compound that contains at least one of calcium (Ca), magnesium (Mg), or sulfur (S);
“micronutrient” means a nutrient element that is different from one that qualifies as a macronutrient or a secondary nutrient including specifically, but not necessarily exclusively, manganese (Mn), molybdenum (Mo), copper (Cu), zinc (Zn), iron (Fe), and boron (B);
“micronutrient compound” refers to a compound, for example zinc oxide (ZnO), or to a complex, e.g., chelated iron, that contains a micronutrient;
“micronutrient particle” refers to a solid particle that comprises, consists of, or consists essentially of a micronutrient (elemental) or a micronutrient compound; typically, micronutrient particles will consist of or will consist essentially of one or more micronutrient compounds, meaning that the micronutrient particles contain at least 70, 80, 90, 95, 98, or 99 percent of one or more micronutrient compounds;
“organic liquid” means an organic compound that is not water-immiscible oil, that can be provided as a liquid in the range of 0° to about 50° C. and atmospheric pressure;
“water-miscible liquid” is a liquid that combines with water (25° C., 1 atm, 6≤pH≤8), in all proportions, to produce a single phase homogeneous solution;
“water-compatible liquid” refers to a liquid such as an organic liquid or a liquid carrier as described herein, that has a solubility in water (25° C., 1 atm, 6≤pH≤8) of at least 10, 15, 20, 25, 30, or 50 grams per liter; any liquid that is water-miscible is also considered to be water-compatible;
“aprotic liquid” means an organic liquid that does not contain a hydrogen atom bound to an electronegative atom selected from O, N, or S;
“free flowing” means generally resistant to aggregation and caking, as well as able to be poured in humid conditions;
“suspension” means a heterogeneous mixture wherein particulate solids are present throughout the volume of a liquid but in which those solids can, over time and under the influence of gravity, fall out of their suspended state;
“chelating polymers” means a polymer with multiple mer that include acid and/or amide groups;
“comprising” means including but not limited to the listed ingredients;
“consisting of” means including only the listed ingredients and minor amounts of impurities or materials typically found in or with those ingredients; and
“consisting essentially of” means including only listed ingredients, impurities commonly found in those ingredients, and minor amounts of unlisted ingredients that do not materially affect the basic characteristics of a described composition including, but not limited to, additives and adjuvants, e.g., less than 5, 2, 1, 0.5, or 0.1 weight percent of such unlisted ingredients.

In one aspect, the invention relates to a suspension that is useful as a fertilizer coating composition. The suspension includes solid micronutrient particles suspended in water-miscible liquid carrier. The liquid carrier includes one or more water-miscible organic liquids.

In another aspect the invention relates to a method of applying micronutrient to solid fertilizer particles. The method includes providing a suspension as described herein, and applying the suspension to solid fertilizer particles.

In another aspect, the invention relates to fertilizer particles that contain a suspension as described, as a coating applied to surfaces of the fertilizer particles.

In yet another aspect, the invention relates to a method of applying fertilizer to a field. The method includes spreading onto the field, fertilizer particles as described herein, that include a coating composition as described.

### DETAILED DESCRIPTION

As summarily explained above, particulate solid fertilizers can be provided with coatings that contain one or more micronutrients, by use of a coating composition and process that do not involve a high amount of water-immiscible oil as part of the coating composition.

The particulate solid fertilizer used in the process can be classified as a single nutrient material (just one of N, P or K) or a multi-nutrient material (at least two of N, P, and K).

Example N-containing compounds used in particulate solid fertilizers include ammonia, ammonium nitrate, urea, and double salts, e.g., calcium ammonium nitrate.

Example P-containing compounds used in particulate solid fertilizers include compounds that contain the phosphate (PO₄⁻³) anion and that are derived from minerals that contain or yield that anion, for example, fluorapatite and hydroxyapatite. The phosphate anion often is provided in so-called single and triple superphosphate forms, as well as blends thereof.

Each of the foregoing also can be provided in so-called binary form, i.e., a compound that includes both N and P, examples of which include NH₄H₂PO₄ and (NH₄)₂HPO₄. Further, the Odda process can be used to provide a blend of N- and P-containing products (phosphoric acid and calcium nitrate).

K-containing compounds include any of a variety of compounds, including but not limited to K₂O, KCl, K₂SO₄, K₂CO₃, and KNO₃. Such ionic compounds often are provided from potash.

The amount of macronutrient (e.g., P, K, or N) in a solid particulate fertilizer that includes a coating as described may be any useful amount. Similarly, any known secondary nutrient, in any commercially desirable amount, can be included in the solid particulate fertilizer, e.g., as part of the coating composition.

According to the present invention, a solid particulate fertilizer can be provided with a coating that contains one or more micronutrients, e.g., in the form of one or more different types of suspended micronutrient particles, in a liquid carrier.

Micronutrients typically are provided in ionic compound form, although some metals (particularly Fe) are easier to provide as a complex with one or more chelating ligands (e.g., EDTA). In practice, the particular form of the compound or complex has not been found to be particularly important to the practice of the process described herein.

Although not required, micronutrient particles can be milled for the purpose of reducing an average particle size (e.g., diameter) of a collection of micronutrient particles, simultaneously increasing surface area of the collection of particles. However, in some example methods and compositions of the present description, micronutrient particles that exhibit relatively large particle sizes may be preferred, advantageously permitting a milling step to be avoided and thereby reducing manufacturing complexity and cost. Micronutrient particles having particle sizes in a range from about 30 to about 100 μm, such as a particle size of from 75±25 μm, may be preferred for certain example compositions of the present description. A step of milling these particles typically is not necessary to produce a collection of micronutrient particles that includes substantial percentage of particles (e.g., at least 50, 60, 70, or 80 percent based on total number of particles) having a particle size in that range.

According to the present description, a micronutrient suspension product (a.k.a. a coating composition) contains solid micronutrient particles suspended (e.g., dispersed), not substantially or completely dissolved, in a liquid carrier that contains organic liquid, i.e., in a water-miscible liquid carrier with a low amount or no amount of water-immiscible ingredients. The liquid carrier can contain mostly (e.g., at least 50 percent by weight), predominantly, or almost entirely organic liquid as described herein. Alternately, the liquid carrier can contain a substantial amount of water (e.g., up to or greater than 20, 25, 30, 40, or 50 weight percent water based on total weight liquid carrier) in combination with one or more water-miscible organic liquid.

Relative to certain previous micronutrient suspensions, a micronutrient suspension of the present description can contain a reduced and relatively low amount of water-immiscible oil, or substantially no water-immiscible oil. Example micronutrient suspensions may instead be made from a liquid carrier that is made of (comprises, consists of, or consists essentially of) water-miscible organic liquid and optional water, with any useful amounts of water and water-miscible organic liquid. The liquid carrier generally, and the water-miscible organic liquid more specifically, can preferably be efficiently removable from a surface using water that does not contain any added cleaning agent.

Micronutrient particles that contain one or more micronutrients of interest for a given coating composition can be introduced to the organic liquid (e.g., to the liquid carrier) by any method or technique, and using standard processing equipment. This typically can be done at or near ambient temperature.

The liquid carrier can include one water-miscible organic liquid and optional water, or a mixture of two or more water-miscible organic liquids combined with optional water. In certain embodiments, each of one or more water-miscible organic liquids of a liquid carrier can be of a type that is considered to be generally regarded as safe by a regulatory body such as the U.S. EPA, U.S. FDA, U.S. FDC, etc., as well as being water-miscible or water-compatible.

In certain embodiments, the liquid carrier is substantially free of water, meaning that no liquid water is intentionally added to or contained in the liquid carrier. For example, a suspension as described may contain water, may not require water, and example suspensions may contain less than 20, 10, 5, 2, 1, or 0.5 weight percent water from any source, e.g., by being intentionally added to the suspension or by being present, incidentally, in an ingredient used to form the suspension.

According to other example coating compositions, the liquid carrier can contain a significant amount of water combined with one or more organic liquids. Water may be useful in a liquid carrier because water is a convenient and inexpensive chemical ingredient and can be used in an amount that reduces or avoids the need for other types of water-miscible liquids in a liquid carrier such as organic solvents, which may be less favored due to cost, convenience, commercial availability, or toxicity. The amount of water in a liquid carrier or a suspension can be an amount that is useful to produce a coating composition that is stable and effective as a coating composition as described. For example, water may be included in a liquid carrier and a coating composition an amount that allows the liquid carrier to be combined with micronutrient particles (and other optional ingredients such as biostimulant, urease inhibitor, nitrification inhibitor or additives) to produce a suspension that contains the suspended micronutrient particles in solid form as described, preferably in a coating composition that has stability as described herein. Additionally an amount of water may be effective to produce a coating composition that can be effectively and efficiently applied to a fertilizer to form coated fertilizer particles without causing undue negative effects when applied to the fertilizer particles, e.g., without causing the fertilizer particles to dissolve to an undesired extent.

Example liquid carriers may contain up to or greater than (at least) 10, 20, 25, 30, 40, 50 weight percent water based on total weight liquid carrier. According to these example coating compositions, the coating composition may contain, e.g., from 5 to 45 weight percent, e.g., up to or greater than (at least) 10, 15, 20, 25, 30, 35, or 40 weight percent water based on total weight coating composition.

Useful and preferred liquid carriers may contain a low amount of or be free of oils, particularly oils that are not water-miscible, i.e., oils that are not “water-miscible liquids” or “water-compatible liquids” as described herein. For example, a liquid carrier or a suspension as described may contain an amount of one or more such oils, but may not require the presence of any water-immiscible oil, and example suspensions may contain less than 10, 5, 2, 1, or 0.5 weight percent total immiscible oil or immiscible oil ingredient.

As used herein, the term “oil” is given its understood meaning within the agricultural chemical arts. Consistent with that meaning, non-exclusive examples of oils include fatty acid esters, seed oils, petroleum oils, fatty acids, fatty alcohols, fatty ethers, fatty amides, glycerides, silicones (silicone oils) and mixtures of two or more of these. The oil can be liquid at ambient temperature, such as at a temperature in a range from 40 to 70 degrees Fahrenheit.

The term “oil ingredient” used herein refers to a composition that includes a high concentration of oil, such as at least 70, 80, 90, or 95 weight percent oil based on total weight of the composition. An oil ingredient can include the oil as one constituent, and can contain low amounts of water and non-oil materials (e.g., impurities or a co-ingredient such as a surfactant), preferably less than 10, 5, 2, or 1 percent of these or other non-oil materials based on the total weight of an oil ingredient. When used in the present application and claims, the term “oil” refers to oil compounds themselves, and the term “oil ingredient” refers to a composition that contains one or more oil (compound), which may be a commercially obtained material, that can also include low levels of non-oil impurities, co-ingredients, and water.

Fatty acid esters include those having the general formula:

R′C(O)—O—CₙH₂ₙ₊₁

wherein R′ is an alkyl radical having from about 4 to about 22 carbon atoms, and n is a number from 1-4, e.g., n=1 for a fatty acid methyl ester and n=2 for a fatty acid ethyl ester. These ester compounds can be derived by the esterification of a fatty acid with an alkanol. Example fatty acid esters are methyl and ethyl esters derived from the esterification of unsaturated fatty acids having from about 18 to about 22 carbon atoms. Common methyl esters include methyl oleate, methyl laurate, and methyl soyate. Common ethyl esters include ethyl oleate and ethyl canolate. Example fatty acids from which the fatty acid esters may be derived include but are not limited to coconut, soy, and other vegetable oils, tallow, etc.

Other example oils include alkoxylated fatty acid esters. These include fatty acid esters such as those listed above, which are alkoxylated with ethylene oxide, propylene oxide, and combinations thereof.

Still other example oils include fatty alcohols, which may be saturated or unsaturated, branched or linear C8-C20 alcohols, e.g., C8-C20 alcohols.

Example fatty acids include those composed of an alkyl group containing from 4 to 22 carbon atoms, and a terminal carboxyl group. The fatty acid may be saturated such as, for example, butyric, lauric, palmitic, and stearic, or unsaturated such as, for example, oleic, and linolenic.

Seed oils include those derived from vegetables, seeds, and nuts, and include, but are not limited to, castor oil, coconut oil, soybean oil, vegetable oils, and the like. Seed oils include processed seed oils that have been processed to produce methylated or ethylated seed oils, commonly referred by the abbreviations MSO and ESO (for processed soybean oil). MSOs and ESOs, and other processed seed oils can be produced by hydrolysis (cleaving) of the glycerol molecule from the fatty acids. The fatty acids are then separated from the glycerol molecule and other water soluble components and esterified with methanol (to produce MSO) or ethanol (to produce ESO).

Useful petroleum oils include, but are not limited to, petroleum and petroleum-derived oils such as mineral oil.

Silicones and silicone oils include chemical compounds, molecules, polymers, etc., that include alternating silicone and oxygen atoms, e.g., compounds referred to as liquid “siloxane” polymers; e.g., organosilicon materials having alternating —Si—O—Si— linkages of the formulae H(OSiH₂)ₙOH and (OSiH₂)ₙ, optionally with organic (e.g., alkyl or aromatic) sidechain groups attached to the silicone atoms, e.g., polydimethylsiloxane.

As opposed to oils, particularly water-immiscible oils, organic liquids that may be preferred for use in a liquid carrier as described include non-oil organic liquids that are water-miscible and that do not substantially dissolve micronutrient compounds of micronutrient particles being carried thereby. In some embodiments, preference can be given to water-miscible organic liquids that also do not require the presence of a dispersant or other co-ingredient to avoid flocculation, aggregation, or sedimentation of solid micronutrient particles suspended in a coating composition.

The liquid carrier may contain one or a combination of two or more different types of water-miscible organic liquids, with the type and amount of organic liquid, or combination of organic liquids, being any that are useful as an ingredient of a liquid carrier of the present description. Examples of useful organic liquids include organic liquids known to be effective organic solvents, as the term “solvent” is typically used in chemical and agricultural chemical arts. Organic solvents are generally understood to include liquid organic compounds that are effective to form a homogeneous solution with a solute that becomes dissolved in the solvent. Consistent with this meaning, and for purposes or the present description, “solvents” include organic liquids that are liquid at room temperature and at least somewhat above room temperature and somewhat below room temperature (e.g., at 0 F, 20 F, 40 F, 100 F, 120 F, or 140 F), at atmospheric pressure. An organic solvent as described herein is not used for a purpose of dissolving a micronutrient as a solute. Instead, organic solvent is used as a liquid medium to suspend (not dissolve) micronutrient particles. Still the term “solvent” will be used with these organic liquids because the term otherwise applies to these liquid organic materials.

Organic solvents that are useful in a liquid medium as described include water-miscible organic solvents that effectively suspend solid micronutrient particles as also described. Examples of particular solvents for this use include solvents that are aprotic, polar, or both polar and aprotic, and water-miscible (including water-compatible). Specific examples of useful or preferred organic liquids include dimethyl sulfoxide, n-methyl pyrrolidone, among others.

An organic liquid, a combination of two or more organic liquids, or a liquid carrier as described, is considered to be “water-miscible” if the liquid can be combined with water, in all proportions, to produce a single phase homogeneous solution, at a particular temperature; e.g., water and the organic liquid fully dissolve in each other, at a given temperature, at any concentration, to form a single-phase, homogeneous liquid solution that is preferably water-miscible or water-compatible. An example of a water-miscible organic liquid, for the purpose of illustration, is ethanol. Water and ethanol combine in all proportions to form a single phase solution.

Preferred organic solvents for use as an organic liquid include those that are water-miscible, water-compatible, aprotic, polar, or two or more of these. Organic solvents that are considered to be water-compatible, water-miscible, or both include but are not limited to ketones such as acetone, methyl-ethyl ketone (MEK), and isophorone, dimethylformamide (DMF), dimethyl sulfoxide (DMSO), sulfolane, dioxane, alcohols such as methanol, ethanol, isopropanol, etc., dimethyl acetamide, glycols such as ethylene glycol, propylene glycol, etc., glycol ethers (e.g., ethylene glycol monobutyl ether) and esters, glycerols, polyglycol derivatives, lower alkyl lactates including ethyl, propyl and butyl lactate, alkanolamines, amino alcohols, heterocyclic alcohols, hexamethylphosphoramide, and certain cyclic compounds that contain an oxygen atom in a ring structure, e.g., tetrahydrofuran (THF).

Non-limiting examples of useful or preferred aprotic organic solvents include dichloromethane, sulfoxides such as DMSO and dimethyl sulfone; linear ketones such as acetone, 2-butanone (MEK), 2- or 3-pentanone, etc.; cyclic compounds such as cyclohexanone; cyclic compounds which contain a nitrogen atom in their ring structure, including N-alkylpyrrolidones such as N-methyl pyrrolidone (NMP) and N-octyl pyrrolidone as well as 1,3-dimethyl-3,4,5,6-tetrahydro-2(1H)-pyrimidinone and 1,3-dimethyl-2-imidazolidinone; cyclic compounds that contain an oxygen atom in a ring structure, including isophorone, gamma-valerolactone, gamma butyrolactone, and alkylene carbonates (particularly ethylene and propylene carbonate); aromatic compounds such as acetophenone; lower alkyl acetates including methyl and ethyl acetate; any of a variety of phosphate esters that include triethyl phosphate; trimethyl phosphate; esters of polycarboxylic acids; and the like.

Phosphate esters that may be potentially useful as an organic solvent as described include those that are defined by the general formula P(O)—[ZOR¹]₃ where each R¹ independently is a hydrogen atom or a hydrocarbyl group such as alkyl, cyclo-alkyl, alkaryl, aryl, aralkyl, etc., and each Z is an optional linking group defined by the formula (OR²)ₙ where n is an integer of from 1 to 20 and each R² independently is a (CH₂)ₘ group with m being 2 or 3; where an aprotic organic liquid is desired, each R¹ is a hydrocarbyl group. Non-limiting examples of such phosphate esters include tristyrylphenol ethoxylate and nonylphenol ethoxylate phosphate esters. Such phosphate esters are commercially available from a variety of suppliers.

Also potentially useful as an organic solvent, as described, are dibasic ester solvents and terpene alcohols.

Preferred organic solvents include water-miscible organic solvents that optionally in combination with water can perform as a liquid carrier to suspend a desired level (concentration) of micronutrient particles in a relatively small volume of the liquid carrier, i.e., that can form a liquid carrier that is effective to contain and suspend a relatively high concentration of solid micronutrient particles, optionally with additional ingredients such as urease inhibitor, biostimulant, nitrification inhibitor, and others as described. A relatively low amount of liquid carrier (including organic solvent) in a suspension helps to avoid aggregation of coated solid fertilizer particles while the suspension is being applied to solid fertilizer particles.

If a chosen organic solvent has a relatively high freezing point, the liquid carrier can include an additive (adjuvant) that is effective to lower the freezing point of the liquid carrier, i.e., a freezing point depressant. For example, because DMSO has a freezing point of about 19° C., a coating composition that includes DMSO as organic solvent and that is intended for use at temperatures at or below that temperature can include a sufficient amount of a liquid or solid material that reduces the freezing point of the liquid carrier.

If desired, the viscosity of the liquid carrier can be increased by adding a low amount, e.g., up to about 5 weight percent (based on total weight suspension) of one or more rheological agent, e.g., a thickener or suspending agent, such as, for example, fumed silica; magnesium aluminum silicate; a polymeric thickener (which may be water-miscible) such as hydroxymethyl cellulose (HMC), hydroxyethyl cellulose (HEC), hydroxypropyl cellulose (HPC), hydroxypropyl methylcellulose (HPMC), xanthan gum; a clay (including but not limited to bentonite), and the like.

For purposes of this description, the combination of one or more different types of solid micronutrient particles distributed in (suspended in) liquid carrier is sometimes referred to as a “coating composition.” A coating composition generally will include water-miscible liquid carrier (containing organic solvent and optional water), suspended micronutrient particles, and may optionally additionally include one or more surface-active ingredients that may also be water-miscible organic liquids, such as surfactant, a wetting agent, a dispersant, or combinations of these.

A dispersant can be used to keep distinct suspended micronutrient particles from agglomerating. A wetting agent can be used to increase the affinity of a suspended micronutrient particle to an organic liquid and/or a dispersant. Suitable dispersants may be natural or synthetic and include fatty acids, mono- and diglycerides, poly-condensed fatty acids, polymerized fatty acid esters, fatty acid modified polyesters, carboxylic acid-containing polymers such as polyacrylate polymers (e.g., polyacrylic acid), non-ionic block copolymers; a useful dispersant may be an effective surface-active agent, and examples of useful dispersants may be selected from the description of surfactants herein, many of which may be effective dispersants. Preferably a dispersant or a wetting agent is water-miscible, e.g., is a water-miscible organic liquid. A water-miscible dispersant is considered to be a type of water-miscible organic liquid.

Alternately or additionally, a coating composition may include one or more water-miscible surfactants; (e.g., a water-miscible surfactant is considered to be a water-miscible organic liquid). Essentially any material having surface active properties in water can be used, regardless of whether water is present in the liquid carrier of the coating composition. When present, a water-miscible surfactant or a combination of two or more water-miscible surfactants may typically be present at less than 10 percent by weight, e.g., less than 5 percent by weight, less than 3 percent by weight, and preferably less than 2 percent by weight, based on total weight coating composition.

Potentially useful nonionic surfactants include, but are not limited to, sodium polyoxyethylene glycol dodecyl ether, N-decanoyl-N-methylglucamine, digitonin, n-dodecyl β-D-maltoside, octyl β-D-glucopyranoside, octylphenol ethoxylate, tristyrylphenol ethoxylate phosphate ester, polyoxyethylene (8) isooctyl phenyl ether, polyoxyethylene sorbitan monolaurate, polyoxyethylene (20) sorbitan cholamidopropyl) dimethylammonio]-2-hydroxy-1-propane sulfonate, 3-[(3-cholamidopropyl) dimethylammonio]-1-propane sulfonate, 3-(decyldimethylammonio) propanesulfonate inner salt, and N-dodecyl-N,N-dimethyl-3-ammonio-1-propanesulfonate.

Potentially useful zwitterionic surfactants include sulfonates (e.g. 3-[(3-cholamidopropyl)dimethylammonio]-1-propanesulfonate), sultaines (e.g. cocamidopropyl hydroxysultaine), betaines (e.g. cocamidopropyl betaine, lauryl dimethyl betaine, etc.), and phosphates (e.g. lecithin).

Potentially useful anionic surfactants include, but are not limited to, ammonium lauryl sulfate, dioctyl sodium sulfosuccinate, perflourobutanesulfonic acid, perfluorononanoic acid, perfluorooctanesulfonic acid, perfluorooctanoic acid, potassium laurylsulfate, sodium dodecylbenzenesulfonate, sodium laureth sulfate (SLES), sodium lauryl sarcosinate, sodium myreth sulfate, sodium pareth sulfate, sodium stearate, sodium chenodeoxycholate, N-lauroyl-sarcosine sodium salt, lithium dodecyl sulfate, 1-octanesulfonic acid sodium salt, sodium cholate hydrate, sodium deoxycholate, sodium dodecyl sulfate (SDS or SLS), sodium glycodeoxy-cholate, and the alkyl phosphates set forth in U.S. Pat. No. 6,610,314.

Potentially useful cationic surfactants include, but are not limited to, cetylpyridi-nium chloride (CPC), cetyl trimethylammonium chloride, benzethonium chloride, 5-bromo-5-nitro-1,3-dioxane, dimethyldioctadecylammonium chloride, cetrimonium bromide, dioctadecyl-dimethylammonium bromide, tetradecyltrimethyl ammonium bromide, any of a variety of benzalkonium chloride (BK) compounds, hexadecylpyridinium chloride monohydrate and hexadecyltrimethylammonium bromide, with the benzalkonium chloride being a preferred material.

For other potentially useful materials, the interested reader is directed to any of a variety of other sources including, for example, U.S. Pat. Nos. 4,107,328, 6,953,772, and 7,959,943.

Optionally, a coating composition may also contain an ingredient that contains macronutrient such as nitrogen, potassium, or phosphorus, i.e., a “macronutrient diluent.” A user of the coating composition may consider the presence of macronutrient either useful or advantageous. From a formulation standpoint, a macronutrient that is in the form of a relatively dense macronutrient-containing salt that is soluble in the liquid carrier may also be useful or may advantageously have an effect of increasing the stability of the suspension. Preferred macronutrient diluents may include salt compounds that contain nitrogen, phosphorus, or potassium, and that are soluble (i.e., dissolve completely) in the liquid carrier, in water (i.e., are water soluble), or both, in amounts and at temperatures as described herein. Examples of macronutrient diluents that are in the form of generally water soluble salts include: potassium chloride, monoammonium phosphate, diammonium phosphate, potash, ammonium sulfate, and urea (but not necessarily urea salts).

Preferred macronutrient diluents can remain fully dissolved in a coating composition, liquid carrier, or in water, at 40 degrees Fahrenheit, e.g., at 32 or 30 degrees Fahrenheit, in an amount of up to 20 weight percent macronutrient diluent, based on total weight coating composition, liquid carrier, or water, e.g., in an amount in a range from 0.5 to 18, or in an amount of at least or greater than 1 to 2, 5, 10, or 15 weight percent based on total weight liquid carrier, water, or coating composition. Preferred macronutrient diluents can remain fully dissolved in a coating composition as described, in an amount as specified, during weeks or months of non-agitated storage as described.

The term “liquid carrier” refers to the liquid portion of a suspension (or coating composition), meaning all ingredients other than the suspended micronutrient particles and any other potential solid or suspended ingredients. The liquid carrier includes all liquid ingredients that combine to form a single-phase liquid (e.g., solution) within which the solid micronutrient particles are suspended. Ingredients of a suspension that are considered to be part of the liquid carrier include any all water and water-miscible organic liquids (optionally combinations of two or more organic liquids), which include water-miscible organic solvent, optional water-miscible surfactant, dispersant, or other surface active agent, any water-miscible polymer such as an optional thickener, water (if present), and other non-required (optional) ingredients that may be dissolved in the liquid carrier even if not preferred, such as an amount of oil, dye or colorant, or another non-solid phase ingredient.

A preferred coating composition may be a suspension that contains from 35 to 80 weight percent liquid carrier and from 20 to 65 weight percent suspended solid micronutrient particles, e.g., up to or in excess of 40, 45, 50, or 60 weight percent liquid carrier, and up to or in excess of 20, 25, 30, 35, 40, 45, 50, 55, or 60 weight percent suspended solid micronutrient particles, based on total weight coating composition.

The liquid carrier may contain up to or greater than (e.g., at least) 50, 60, 70, 80, 90, or 95 weight percent water-miscible organic liquid, which may be a single type of organic liquid or a combination of two or more different types of organic liquids, especially one or a combination of water-miscible or water-compatible organic liquids, based on total weight liquid carrier. The remaining portion of the liquid carrier may include water as described herein.

In some embodiments the liquid carrier contains a high concentration of water-miscible organic solvent, e.g., at least 50, 60, 70, 80, 90, or 95 weight percent water-miscible organic solvent, based on total weight liquid carrier, which may be a single type of organic solvent or a combination of two or more different types of organic solvents. The remaining portion of the liquid carrier may include water as described herein.

The total amount of water-miscible liquid carrier (containing organic solvent and optional water) in a coating composition may be any useful amount and consistent with the present description. Example coating compositions may contain from 10 to 80 weight percent water-miscible liquid carrier based on total weight coating composition, e.g., up to or at least 40, 50, 55, 60, 65, or 70 weight percent water-miscible liquid carrier based on total weight coating composition.

Example coating compositions, with respect to amounts of water-miscible liquid carrier (e.g., water-miscible organic solvent, water-miscible surfactant (including dispersant), water-miscible polymer, water, etc.) and suspended solid micronutrient particles, may contain from 35 to 80 weight percent water-miscible liquid carrier, and from 20 to 65 weight percent suspended solid micronutrient particles, e.g., up to or in excess of 40, 45, 50, 60, 65, or 70 weight percent water-miscible liquid carrier, and up to or in excess of 30, 35, 40, 45, 50, 55, or 60 weight percent suspended solid micronutrient particles, based on total weight coating composition.

The coating composition may contain other ingredients, as described herein, typically in a total amount that does not exceed 20, 15, 10, or 5 weight percent of the total coating composition. The coating compositions may consist of or consist essentially of suspended solid micronutrient particles, water-miscible liquid carrier (e.g., water-miscible organic solvent, water-miscible surfactant (including dispersant), water-miscible polymer, water, etc.) as described, and a minor amount of optional ingredients as described herein, such as not more than 20, 15, 10, or 5 weight percent of such optional ingredients (including biostimulant, urease inhibitor, nitrification inhibitor, etc.) based on total weight coating composition.

The compositions generally take the form of relatively concentrated suspensions, which desirably have viscosities and densities that permit them to be transported through lines or hoses when impelled by, for example, a gear-, centrifugal- or diaphragm-type pump. To assist in keeping the micronutrient particulate solids suspended so as to permit impelled movement of the coating composition, one or more of the aforedescribed dispersants, wetting agents, and/or surfactants (any one or more of which is water-miscible) can be incorporated into the coating composition.

A coating composition alternatively or additionally may include up to 5 weight percent, e.g., up to 4 weight percent, and typically not more than 3 weight percent, based on total weight coating composition of one or more polymers to assist in viscosity control and/or in-use benefits such as water conditioning. A polymer may preferably be a liquid or may freely dissolve in water, in which instance the polymer is considered water-miscible, e.g., a water-miscible organic liquid. A particular class of potentially useful polymers is chelating polymers, non-limiting examples of which include polyacrylic acid, polymaleic acid, and the like, which may preferably be water-miscible.

The composition alternatively or additionally can include one or more formulation aids, i.e., additives or adjuvants. A non-exhaustive list of potentially useful aids includes, but is not limited to, thickeners, antifoaming agents, dyes, pigments, biostimulants, non-polymeric chelators, anti- or defoamers, and the like. Preferred such ingredients may be water-miscible, e.g., a water-miscible liquid. The amount of any particular adjuvant will be determined by its chemical nature and the desired impact on chemical or physical properties of the composition, although common amounts of a particular additive in a coating composition may be in a range from 0.5 to 15 weight percent based on total weight coating composition.

Depending on the freezing point of the organic liquid, some example coating compositions may also (optionally) contain a freezing point depressant. An example of a freezing point depressant is dicyandiamide, for use with DMSO as an organic solvent.

Preferred examples of coating compositions may be prepared from ingredients that can be combined into a coating composition as described without significant flocculation, aggregation, or sedimentation of the solid micronutrient particles, preferably without the need for a dispersant being present, and for a range of particle sizes of the micronutrient particles.

Example coating compositions include at least 1 weight percent, and up to or at least 10, 15, 20, 25, 30, 35, 40, 50, 55, 60 or 70 weight percent, of one or more micronutrient compounds (alternately, micronutrient particles), based on total weight coating composition. A micronutrient compound is a compound that contains a desired micronutrient (e.g., ZnO for Zn, colemanite for B, etc.). The balance of the coating composition is available to contain ingredients of a liquid carrier, which may contain one or more water-miscible organic liquids as described in amounts that will take up the remaining available weight percentage of the coating composition.

For efficient use of a coating composition as described, to allow micronutrient to be combined with solid fertilizer in a desired relative amount of micronutrient to solid fertilizer, and with a relatively low or minimal amount of liquid carrier, a coating composition may preferably contain a relatively high concentration of the micronutrient particles. For example, a preferred coating composition may include up to or greater than (at least) 20, 30, 40, 50, 55, or 60 percent by weight suspended micronutrient particles, which may include a single micronutrient element or two or more different micronutrient elements.

The micronutrient particles contain micronutrient in the form of micronutrient compounds that contain only a portion of micronutrient in elemental form. Consequently, the amount of elemental micronutrient in the coating composition will be a fraction of the amount of the micronutrient particles in the composition. Examples of zinc-containing micronutrient compounds include zinc oxide (Zn) and zinc sulfate (ZnSO₄). Examples of manganese-containing micronutrient compounds include manganese (II) chloride (MnCl₂) and manganese (II) carbonate (MnCO₃). Examples of copper-containing micronutrient compounds include copper (I) oxide (Cu₂O) and copper (II) oxide (CuO). An example of a boron-containing micronutrient compound is colemanite (Ca₂B₆O₁₁ 5H₂O). An amount of elemental micronutrient that is present in a coating composition will correspond to the amount of elemental micronutrient in a micronutrient compound, the amount of micronutrient compound in micronutrient particles (which is normally a relatively high percent), and the amount of micronutrient particles in the coating composition. Typical micronutrient particles will contain at least 80, 85, 90, or 95 weight percent micronutrient compound.

Formulating a suspension that contains a relatively high concentration of micronutrient, i.e., a relatively high concentration of suspended micronutrient particles, however, is challenging on multiple fronts. One challenge is stability of a suspension. Micronutrients are metals, which are substantially more dense than organic materials. An initial challenge is merely to cause a high concentration of a metal-containing solid micronutrient particles to become suspended by a liquid carrier, with even short term stability. Often, some type of co-ingredient is used to cause micronutrient particles to become suspended in a liquid carrier, and to remain suspended within the liquid carrier for a commercially useful amount of time. The co-ingredient may be, e.g., a dispersant, a thickener, or a suspending agent to inhibit sedimentation, stratification, as well as flocculation, agglomeration, precipitation, or other potential inhomogeneities of a suspension. Other co-ingredients may also be helpful, for example, to improve flow properties (including at low temperatures), or to facilitate processing or cleaning, such as surfactant, emulsifier, wetting agent, detergent, dye, or colorant. A goal of a high concentration of the micronutrient is made even more difficult by the high concentration of micronutrient particles reducing the amount of the formulation, on a percentage basis, that can be used for one or more of these co-ingredients.

For the present coating compositions, the Applicant has identified that useful or advantageous suspensions can be prepared to contain liquid carrier and suspended solid micronutrient particles, with water-miscible organic liquid used as a major portion of the liquid carrier, and with a minimum amount of water-immiscible oil or substantially no water-immiscible oil as part of the liquid carrier. Preferred liquid carriers and water-miscible organic liquids are capable of containing solid micronutrient particles suspended within the liquid carrier, without being dissolved, at relatively high concentrations, e.g., at least 40, 50, or 60 percent suspended micronutrient particles, based on total weight coating composition.

A maximum amount of suspended micronutrient particle that may be contained and suspended in a particular suspension may depend on the type of micronutrient, among other factors. Suspensions as described may be capable of suspending relatively high amounts of various micronutrients, which provides for efficient application of the micronutrient to solid fertilizer by requiring a relatively lower amount of non-micronutrient materials that make up the liquid carrier, to also be added to the solid fertilizer.

Optionally, a coating composition as described can additionally contain nitrification inhibitor such as dicyandiamide (DCD), e.g., as suspended particles. Dicyandiamide is a chemical compound that is known to be effective as a nitrification inhibitor having the chemical formula (I):

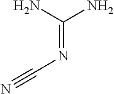

Dicyandiamide, also known as “2-cyanoguanidine,” can be made by known methods of treating cyanamide with base, and is commercially available. Dicyandiamide (“DCD”) can be provided in the form of concentrated particles, e.g., a collection of particles, flakes, pellets, or granules, etc., that contain a high concentration of dicyandiamide, e.g., at least 90, 95, or 99 weight percent dicyandiamide. A coating composition as described may contain any useful amount of dicyandiamide (meaning 2-cyanoguanadine or particles that contain 2-cyanoguanadine), e.g., from 0.1, 0.5, 1, 2, or 5 weight percent up to or in excess of 10, 15, or 20 weight percent of either 2-cyanoguanadine or particles that contain 2-cyanoguanadine, based on total weight coating composition.

Optionally, a coating composition as described can include urease inhibitor dissolved in the liquid carrier. One class of effective urease inhibitors is the class of phosphoric triamide compounds disclosed in the U.S. Pat. No. 4,530,714, which include alkyl thiophosphoric triamide compounds such as N-alkyl thiophosphoric triamides. The compound N-(n-butyl)thiophosphoric triamide (NBPT) is the most common species of thiophosphoric triamide compound currently used in commercial agriculture. In useful or preferred embodiments, a urease inhibitor can be included in a coating composition in a dissolved form, being dissolved in the liquid carrier (in which case the dissolved urease inhibitor can be considered to be a dissolved component of the liquid carrier). An amount of urease inhibitor may be an amount of at least 0.5 or 1 weight percent, e.g., at least 2, 3, or 5 weight percent up to or in excess of 15, 20, or 25 weight percent, based on total weight coating composition.

Optionally, a coating composition may additionally contain biostimulant, e.g., a protein hydrolysate biostimulant (“amino acid” biostimulant) that contains amino acids and polypeptides. Agricultural biostimulants (or, simply, “biostimulants”) are biological or biologically-sourced agricultural additives that may be useful in crop production to enhance plant nutrition, health, growth, quality, or productivity (e.g., yield). The term “agricultural biostimulant” refers to a diverse group of chemical materials that may be derived from naturally occurring organisms, microorganisms, or organic matter, and that will have different modes of action when presented to a plant or soil as a biostimulant. The field of agricultural biostimulants is rapidly growing, and the types of materials considered to be biostimulants are being continually considered and defined.

According to one definition, provided by The European Biostimulants Industry Council (EBIC), biostimulants are identified as follows: “Agricultural biostimulants include diverse formulations of compounds, substances and micro-organisms that are applied to plants or soils to improve crop vigor, yields, quality and tolerance of abiotic stresses. Biostimulants foster plant growth and development throughout the crop life cycle from seed germination to plant maturity in a number of demonstrated ways, including but not limited to: Improving the efficiency of the plant's metabolism to induce yield increases and enhanced crop quality; Increasing plant tolerance to and recovery from abiotic stresses; Facilitating nutrient assimilation, translocation and use; Enhancing quality attributes of produce, including sugar content, color, fruit seeding, etc.; Rendering water use more efficient; Enhancing soil fertility, particularly by fostering the development of complementary soil micro-organisms.”

In alternate terms, agricultural biostimulants include compounds or substances that can be applied to a plant or soil to regulate and enhance a crop's physiological processes, thus making the physiological processes more efficient and improving a feature of the crop. A biostimulant may act on plant physiology through any of various physiological pathways to improve a feature of the crops such as crop vigor, yield, quality (e.g., size, coloration, or nutritional content), post-harvest shelf life, or some other feature. Some biostimulants are effective to stimulate the root zone of a plant, producing a positive effect on the plant's overall health by increasing the uptake of vital nutrients to the plant. Other biostimulants affect a property of the soil, such as to improve the ability of the soil to retain moisture or nutrients and deliver those to a plant. Some identifiable groups of biostimulants include humic materials, amino acids, plant sugars, seaweeds and seaweed extracts, mycorrhizal fungi, trace elements, and growth promoting hormones.

As used herein, the term “biostimulant” can exclude chemical materials that are effective as a fungicide, insecticide, or herbicide, as those terms are used and understood within the agrochemical and farming industry to refer to chemical materials that are effective to manipulate or control undesirable pests, fungus, or vegetation (weeds), e.g., to prevent, destroy, repel, or mitigate fungus, weeds, or pests.

Examples of amino acid biostimulant products are commercially available under various tradenames, including Amefert; Protaminal®; Essential Plus® 1-0-1 (from Growth Products, Ltd.); delfan plus; Biomax, Biomax Solid, and Aminogreen (from AGRI Nova, Spain); WUXAL biostimulants (from AGLUKON); among others. Example amino acid biostimulant products can include a concentrated amount (e.g., at least 5, 10, 15, 20, 30, 40 weight percent, or up to or exceeding 50, 70, or 90 weight percent (for concentrated solid compositions)) of amino acid, polypeptide, or both, optionally in combination with other ingredients such as a liquid carrier with in the product. For example, some amino acid biostimulant products include high levels of L-amino acids such as L-glycine, L-glutamic acid, L-aspartic acid, L-alanine, L-proline, L-leucine, or combinations of these.

One example biostimulant ingredient for use as described is an amino acid and polypeptide biostimulant product sold under the trade name Protifert LMW 8 from Sicit 2000 (Italy). This biostimulant product is sold under the generic CAS number 9015-54-7 “protein hydrolysates.” It can be prepared from bovine hides/skin and once hydrolyzed, results in a blend of amino acids and polypeptides. This ingredient (through the nature of the bovine material and the extent of the hydrolysis) can contain about 60 weight percent organic matter in solution, based on total weight of the biostimulant product (organic matter and other components, such as liquid (e.g., water)). Still using a total product weight basis, about 50 weight percent of the biostimulant product (on a total product basis) is organic, amino acid-based material (this includes both free amino acids and polypeptides). Of the 50 weight percent (total product basis) that is amino acid-based material, about 10 to 20 weight percent (on total product basis) of the biostimulant product may be free amino acid and about 30 to 40 weight percent (on total product basis) of the biostimulant product may be polypeptide.

Other useful biostimulant ingredients include those referred to as “humic substances,” meaning materials that contain a high level of humic acids, fulvic acids, humin, or a combination of these. Commercially available humic substance-based biostimulant ingredients may include at least 5, 10, 20, 30, 40, or 50 weight percent humic substances, i.e., humic acids, fulvic acids, humin, or a combination thereof, based on total weight of the biostimulant ingredients. Humic acids, fulvic acids, and humin, are created by the natural degradation of organic matter. A typical humic substance is a mixture of many molecules, some of which are based on arrangements of multiple aromatic compounds having phenolic and carboxylic substituents, linked together. The molecules can exhibit a charge at one or more carboxylic groups. Humic substances are considered to act as biostimulants by increasing nutrient retention in soil, because the humic substances have a high cation exchange capacity. Additionally, humic substances may modify soil structure by rearranging soil platelets, or may provide a slow-release food source for microbial activity and stimulate root growth.

Another example of a biostimulant is seaweed extract (also referred to as “seaweed extract ingredient,” which is considered a biostimulant ingredient), which can be processed to provide a seaweed extract that contains biostimulants that include auxins, cytokinins, gibberelins, abscisic acid, ethylene, and betaines. Seaweed extracts commonly used for biostimulant products include red algae: Corralina mediterranea, Jania rubens, Pterocladia pinnata; green algae: Cladophora dalmatica, Enteromorpha intestinalis, Ulva lactuca; and brown algae: Ascophyllum nodosum, Ecklonia maxima, Saragassum.

The amount of biostimulant, referring to active biostimulant material such as amino acid, polypeptide, enzyme, or humic substance, an amount of biostimulant (as opposed to a “biostimulant ingredient”) in a coating composition, may be in a range from 0.01 to 20 percent, e.g., up to or in excess of 0.1, 0.5, 1, 5, or 10 weight percent, based on total weight coating composition.

A suspension as described, that contains micronutrient particles (preferably at a relatively high concentration) suspended in a liquid carrier, can be prepared to form a suspension (e.g., a suspension that contains uniformly-distributed suspended particles) that is stable in uniformity over a short term time frame and also preferably over a longer term timeframe. Preferred coating compositions are in the form of a suspension that is sufficiently stable to be prepared, stored, transported, and used (by application to solid fertilizer particles) efficiently and on a commercial basis.

A suspension that is sufficiently stable to be effective as a commercial product may be one that over a period of time in a state of non-agitated storage and transportation, prior to being used, does not exhibit visible (to an unaided eye) precipitation or sedimentation of solids, visible coagulation, visible agglomeration or flocculation, an undesired viscosity build, or a combination of two or more of these. Preferred such suspensions can be capable of being stored, without agitation, (e.g., in a 55 gallon drum or a 275 gallon tote commonly used in the agricultural chemical industry) for weeks (e.g., 3, 6, 9, or 12 weeks) or months (e.g., 3, 4, 6, or 12 months) at ambient temperature or at a reduced temperature (e.g., 72 degrees Fahrenheit, 50 degrees Fahrenheit, or 40 degrees Fahrenheit) without any visible solid precipitate, flocculation, agglomeration, or solid sediment being formed in the suspension, such as sediment formed at a bottom of the storage container.

Alternately or additionally, a preferred suspension, upon storage for a period as described, also does not exhibit undue stratification. “Stratification” refers to settling of particles of a suspension within a container (e.g., a 55 gallon drum or a 275 gallon tote) in an amount that does not produce visible (to an unaided eye) settling or sedimentation of otherwise suspended solid particles at the bottom of the container, but that does produce a measureable gradient in the concentration of suspended solid micronutrient particles between a top portion of a container and a bottom portion of the container. Sedimentation is not visible optically but can be measured by detecting a difference in concentration, density, or both, of samples of the suspension in the container between a top location and a bottom location of the container.

A suspension can be considered to be stratified, after a period of un-agitated storage, if a concentration of micronutrient particles at a bottom location of a container (e.g., at a bottom 5 percent by volume of the container) is at least 1 percent, 2 percent, or 5 percent greater than a concentration of the micronutrient at a top location (e.g., a top 5 percent by volume) of the container. For illustration, a suspension is considered to be stratified if a concentration of suspended micronutrient particles a top portion of the container is 40.0 percent by weight based on total weight of the suspension, and a concentration of suspended micronutrient particles at a bottom portion of the container is 1, 2, or 5 percent greater than 40.0 percent by weight, i.e., 40.4, 40.8, or 42.0 percent by weight based on total weight of the suspension.

Likewise, a suspension can be considered to be stratified after a period of un-agitated storage if a density of the suspension at a bottom location of a container (e.g., at a bottom 5 percent by volume of the container) is at least 1 percent, 2 percent, or 5 percent greater than a density of the suspension at a top location (e.g., a top 5 percent by volume) of the container. For illustration, a suspension is considered to be stratified if a density of the suspension at a top location of the container is 1.500 grams per cubic centimeter, and a density of the suspension at a bottom location of the container is at least 1, 2, or 5 percent greater than 1.500 grams per cubic centimeter, i.e., is at least 1.515, 1.530, or 1.575 grams per cubic centimeter.

Alternately, if a suspension fails to exhibit stability as described in the form of an absence of sedimentation, stratification, agglomeration, flocculation, etc., a suspension as described is preferably capable of being agitated, e.g., mixed by stirring, in a reasonably short period of time, while remaining in the storage container, to substantially re-suspend the solids in the suspension to produce a suspension that contains uniformly distributed suspended solid micronutrient particles. Such a suspension, if the suspension is stratified, contains solid sedimentation at a bottom of the container, or exhibits another inhomogeneity, can be mixed to re-suspend the non-uniformly distributed solid micronutrient particles to form a suspension that contains uniformly-distributed micronutrient particles by mixing the suspension within the container for a period of not more than 1 hour, e.g., not more than 30 minutes, preferably not more than 15 minutes. The materials of the composition can be considered to be effectively re-suspended if the composition can be used by a standard technique, with conventional equipment, to apply the composition to fertilizer, e.g., by spraying the coating composition.

A preferred liquid coating composition can be effectively and efficiently cleaned from equipment that is used for applying the liquid coating composition to solid fertilizer particles, including at relatively low temperatures as mentioned. Methods of the present description include applying coating composition as described to solid fertilizer particles, followed by cleaning the equipment that was used to apply the coating composition by a cleaning method that does not require a cleaning agent, such as by using only or substantially only water that does not contain a cleaning agent.

Previous liquid micronutrient suspensions that contain high amounts of water-immiscible oil as a liquid carrier for solid micronutrient particles can be difficult to remove from surfaces of equipment that is used for transporting, storing, handling, and applying the suspension to solid fertilizer particles. Water-immiscible oil as part of the suspension requires specialized cleaning steps and materials such as a detergent or other type of cleaning agent, for the water-immiscible oil to be removed from surfaces of the equipment. A suspension that contains predominantly water-immiscible oil as a liquid carrier of the suspension will not be removed from equipment surfaces relatively easily without the presence or use of a cleaning agent, such as by rinsing the suspension from surfaces using only water in the absence of a detergent, surfactant, or other cleaning agent.

Preferred coating compositions of the invention, and preferred liquid carriers of the coating compositions, can be water-miscible to facilitate cleaning the coating composition from application equipment by using water that does not contain a cleaning agent such as an emulsifier, detergent soap, surfactant, etc., added to the water for the purpose of cleaning the coating composition from the equipment. A user of a preferred coating composition may apply the coating composition to solid fertilizer particles using application equipment, optionally (if necessary) at a relatively low ambient temperature (e.g., below 50, 40, or 30 degrees Fahrenheit). After use, the application equipment will contain residual coating composition at surfaces of the equipment. Because the coating composition and the liquid carrier of the present description include not more than a low amount of water-immiscible oil, e.g., substantially no water-immiscible oil, and because the liquid carrier is water-miscible (e.g., includes water-miscible organic liquid optionally with water), examples of particularly useful coating compositions of the present description may be removed from surfaces of application equipment by the use of water that does not contain added cleaning agent. This is true even if the coating composition itself does not contain a cleaning agent such as a surfactant, emulsifier, or dispersant.

The cleaning water may be water that is available at a location of application equipment, e.g., from a well, utility, storage tank, or the like, that may optionally be treated by a water conditioning agent, e.g., a “hard water” treatment to remove hard water ions. The cleaning water need not contain and may preferably exclude a cleaning agent such as added detergent, surfactant, emulsifier, wetting agent, or soap, etc., that is designed to remove residual coating composition, especially oil of a liquid carrier thereof. The cleaning water may contain less than 1 weight percent, e.g., less than 0.5, 0.1, or 0.05 weight percent of a cleaning agent such as a detergent, surfactant, emulsifier, wetting agent, or soap.

The cleaning water, without any substantial amount of cleaning agent, e.g., added detergent, surfactant, emulsifier, wetting agent, or soap, may be caused to contact the surfaces of the application equipment to remove residual coating composition from the surfaces. For example, cleaning water may be caused to flow through the equipment for an amount of time and at a rate that will substantially remove any residual coating composition from the surfaces, to produce surfaces that are sufficiently free of coating composition residue to be stored for future use without the need for additional cleaning to remove residual coating composition. The amount of cleaning water needed to produce such cleaning, and the water temperature, may be as needed. For example, cleaning may be accomplished by flowing an amount of cleaning water through the equipment for less than 30 minutes, e.g., less than 15 or 10 minutes, with the cleaning water being at an un-heated temperature, such as a temperature of below 60, below 50, or below 40 degrees Fahrenheit.

In example embodiments, a coating composition as described can be applied to solid fertilizer particles, e.g., pellets, granules, “prills,” or the like, to form coated fertilizer particles. The coated fertilizer particles can subsequently be applied to a field, which may be an unplanted field or a planted field. A crop plant of a planted field may be emerged (e.g., sprouted) or not yet emerged.

The coating composition can be useful with a variety of different types of solid fertilizer particles, including, for example, nitrogen-based (nitrogen-containing) fertilizer particles. Suitable nitrogen-based fertilizers contain nitrogenous compound such as urea, a nitrate salt, ammonium salt, e.g.: ammonium nitrate, ammonium sulfate, ammonium thiosulfate, ammonium polysulfide, ammonium phosphates, ammonium chloride, ammonium bicarbonate, anhydrous ammonia, calcium nitrate, nitrate soda, calcium cyanamide. As one example, a nitrogen-based fertilizer may be in a solid particulate (e.g., granule, prill) form.

A coating composition as described may be applied by spraying the coating composition onto surfaces of the solid particulates, for example by spraying the coating composition onto a collection of particles contained in a large mixer, while mixing the particles and the sprayed coating composition.

A resultant product in the form of coated fertilizer particles can be applied as a field directly to un-planted soil, as can be a typical mode of fertilizing a field for subsequent planting. The coated fertilizer particles may alternately be applied to a planted field either before or after emergence of crop plants. The coated particles may be applied in solid particle (non-dissolved) form, as is common with nitrogen and other NPK particle-type fertilizers. The coated particles may be applied by use of a spreader, at a useful application rate, e.g., by a “broadcast” or “top dressing” type of application technique using conventional application equipment (e.g., a “broadcast spreader”).

A formulation guide for representative compositions is tabulated below.

TABLE 1
formulation guide for representative compositions

| Component | Amount (pbw) |
|---|---|
| micronutrient particles | 40-60 |
| macronutrient diluent | 0-20 |
| organic liquid* and optional water | 32-48 |
| freezing point depressor | 0-5 |
| Thickener (suspending agent) | 0.5-3 |
| surfactant, wetting agent, dispersant, etc. | 0-15 |
| polymer | 0-15 |
| formulation aid | 0-5 |

*preferably an aprotic, water-miscible or water-compatible liquid

Depending on the amounts of micronutrient compound, thickener and/or polymer, a composition can have a wide range of viscosities. A Brookfield viscosity (LV3 spindle at 30 rpm and ˜22° C.) of less than 4000 cps, typically in the range of from 800 to 3000 cps, is common.

Advantageously, a coating composition according to the present invention may have a long shelf live (storage stability) across a wide temperature range, e.g., 0° to 45° C. Storage stability includes retention of characteristics which permit a coating composition to be flowable/pumpable (e.g., viscosity) with insignificant sedimentation and separation for at least 2, 3, or 6 months, preferably at least 9 months, and more preferably 12 months.

A coating composition as described may be prepared by first providing the organic liquid as a liquid carrier, followed by adding thereto the other materials, either together or separately. Although the foregoing can be reversed, providing the liquid carrier first is preferred for ease of mixing. A specific procedure is provided below in connection with a ZnO formulation.

In some embodiments, a composition precursor, which contains some but not all components of a final coating composition, can be prepared along with instructions for the type and amount of additional ingredients which the end user is to add so as to provide a coating composition according to the present invention. For example, a coating composition precursor might be provided with instructions that, if the final coating composition is to be prepared at below a minimum permitted temperature, a suggested amount of a given freezing point depressor is to be added. Other components that might be omitted in various circumstances include dyes and pigments, which assist in visualizing homogeneity and sedimentation.

A composition can be applied to solid fertilizer particles by tumbling, spraying, blending, etc., at temperatures ranging from 0° to 40° C., typically from 3° to 37° C., even more typically from 5° to 35° C. Using commonly available blending equipment, fertilizer particles with an even coating can be provided in one stage or step, with the resulting coated particles being non-dusting and shelf stable.

A solid particulate fertilizer bearing a micronutrient-containing coating according to the present invention may advantageously exhibit less aggregation or sticking than does a similarly sized particle coated using an oil.

A solid particulate fertilizer bearing a micronutrient-containing coating according to the present invention may advantageously also not require a polymeric overcoat layer as described in U.S. Pat. No. 9,199,883.

The relevant portions of any specifically referenced patent and/or published patent application are incorporated herein by reference.

The following examples are intended to provide specific details regarding specific embodiments of the aforedescribed coating compositions, production thereof, and use thereof. Like embodiments set forth in the foregoing description, these are presented by way of example and not limitation. The appended claims and their equivalents define the breadth and scope of the inventive methods and compositions, and the same are not to be limited by or to any exemplary embodiment.

### EXAMPLES

### Example 1: Zn-Containing Composition

Using the amounts shown below in Table 2, a composition was prepared as follows.

To a vessel containing DMSO were added phosphate ester and HPC, sequentially, with continued agitation throughout the additions.

To the thickened solution was added ZnO, with continuous agitation until a smooth and flowing mixture, with no obvious clumps, was obtained.

Dyes then were added and agitation continued until a uniform color was obtained.

TABLE 2
Zn-containing composition formulation

| | Amount (approximate |
|---|---|
| Component | weight percent) |
| DMSO | 46.08 |
| tristyrylphenol ethoxylate phosphate ester | 0.52 |
| Klucel ™ E HPC (Ashland; Covington, KY) | 1.55 |
| AZO66 grade ZnO (U.S. Zinc; Houston, TX) | 51.55 |
| dye, brilliant blue | 0.10 |
| dye, indigo carmine | 0.21 |

Because this coating composition contains DMSO, if the coating composition is to be used at below about 20° C., the composition can be adjusted to include one or more freezing point adjusting liquids or solids; doing so will result in slight changes to the relative amounts of each of the other ingredients. When such an additional solid or liquid is included, it can be added to the DMSO either before, with, or after the other materials.

A composition made from a Table 2 formulation with a small amount of freezing point adjusting agent has a Brookfield viscosity (LV3 spindle at 30 rpm and 22° C.) of 1800±500 cps.

### Example 2: B-Containing Composition

Using a procedure similar to that set forth above in Example 1, a composition containing boron (B) as a micronutrient was prepared using the amounts shown below in Table 3.

TABLE 3
B-containing composition formulation

| | Amount (approximate |
|---|---|
| Component | weight percent) |
| NMP | 40.35 |
| tristyrylphenol ethoxylate phosphate ester | 0.50 |
| Klucel ™ E HPC | 2.00 |
| colemanite* | 57.15 |

*an inoborate (Strunz classification 6.CB.10) formed by alteration of borax and hydrated sodium calcium borate hydroxide

NMP has a melting point of −24° C., so a freezing point adjusting compound typically is not necessary.

Using an LV #3 spindle at 20° C., this composition was found to have a dynamic viscosity of 2.25 Pa·s (2250 cP).

### Example 3: Alternative B-Containing Composition

Using a procedure similar to that set forth above in Example 1, a second composition containing B as a micronutrient was prepared using the amounts shown below in Table 4. Table 4:

B-containing composition formulation

| | Amount (approximate |
|---|---|
| Component | weight percent) |
| DMSO | 40.05 |
| tristyrylphenol ethoxylate phosphate ester | 2.5 |
| Klucel ™ E HPC | 2.00 |
| colemanite | 50.0 |
| dicyandiamide | 5.0 |
| blue pigment 15:3 | 0.5 |
| dye, brilliant blue | 0.05 |

This formulation passed shelf stability tests (no separation, no sedimentation and no significant change in viscosity) at 0° C., room temperature and 45° C. both soon after manufacture and 14 days thereafter. The composition froze when subjected to a temperature of −16° C.

### Example 4: Copper (I)-Containing Composition

TABLE 5
B-containing composition formulation

| | Amount (approximate |
|---|---|
| Component | weight percent) |
| Ethylene glycol | 44.50% |
| tristyrylphenol ethoxylate phosphate ester | 3.00% |
| Water | 15.00% |
| Copper (I) Oxide | 36.00% |
| Aerosil R974 | 1.50% |

Using an LV #3 spindle at 30 rpm and 20° C., this composition was found to have a dynamic viscosity of 1.400 Pa·s (1400 cP).

| Example 5 | Wt % |
|---|---|
| Water | 11.92% |
| Ethylene Glycol | 16.50% |
| Ethylene Glycol monobutyl ether | 10.00% |
| polyoxyethylenated phosphates; 2,4,6-Tris(1- | 3.50% |
| phenylethyl)phenol polyoxyethylenated | |
| phosphat; Phosphoric acid esters of | |
| polyethoxylated tristyryl and distyrylphenol) | |
| Xanthan Gum | 0.08% |
| Colemanite (Ca₂B₆O₁₁•5H₂O) | 57.50% |
| Blue Pigment | 0.50% |
| | 100.00% |

| Example 6 | Wt % |
|---|---|
| Water | 14.40% |
| Ethylene Glycol | 26.75% |
| polyoxyethylenated phosphates; 2,4,6-Tris(1- | 3.25% |
| phenylethyl)phenol polyoxyethylenated | |
| phosphat; Phosphoric acid esters of | |
| polyethoxylated tristyryl and distyrylphenol) | |
| Xanthan Gum | 0.10% |
| Manganese Carbonate (MnCO₃) | 55.00% |
| Blue Pigment | 0.50% |
| | 100.00% |

| Example 7 | Wt % |
|---|---|
| Water | 19.40% |
| Ethylene Glycol | 16.75% |
| Ethylene Glycol monobutyl ether | 10.00% |
| Polyacrylic acid | 3.00% |
| polyoxyethylenated phosphates; 2,4,6-Tris(1- | 0.25% |
| phenylethyl)phenol polyoxyethylenated | |
| phosphat; Phosphoric acid esters of | |
| polyethoxylated tristyryl and distyrylphenol) | |
| Xanthan Gum | 0.10% |
| Zinc oxide | 50.00% |
| Blue Pigment | 0.50% |
| | 100.00% |

| Example 8 | | |
|---|---|---|
| Water | 14.00% | Liqud carrier |
| Ethylene glycol | 34.00% | Liqud carrier |
| Glycerin | 10.00% | Liqud carrier |
| Copper (I) Oxide | 36.00% | Nutrient |
| polyoxyethylenated phosphates; 2,4,6-Tris(1- | 3.00% | Dispersant |
| phenylethyl)phenol polyoxyethylenated | | |
| phosphat; Phosphoric acid esters of | | |
| polyethoxylated tristyryl and distyrylphenol) | | |
| Aerosil 200 | 2.50% | Suspending aid |
| S-721 | 0.50% | Colorant |
| | 100.00% | |

| Example 9 | | |
|---|---|---|
| Water | 29.14% | Liqud carrier |
| Ethylene glycol | 17.00% | Liqud carrier |
| Polyacrylic acid | 3.00% | Dispersant |
| polyoxyethylenated phosphates; 2,4,6-Tris(1- | 0.25% | Dispersant |
| phenylethyl)phenol polyoxyethylenated | | |
| phosphat; Phosphoric acid esters of | | |
| polyethoxylated tristyryl and distyrylphenol) | | |
| Zinc Oxide Maximo 910 | 50.00% | Nutrient |
| Xanthan gum, powder | 0.11% | Suspending aid |
| Blue pigment 15:3 | 0.50% | Colorant |
| | 100.00% | |

| Example 10 | | |
|---|---|---|
| Water | 18.67% | Liqud carrier |
| Ethylene glycol | 19.75% | Liqud carrier |
| polyoxyethylenated phosphates; 2,4,6-Tris(1- | 3.50% | Dispersant |
| phenylethyl)phenol polyoxyethylenated | | |
| phosphat; Phosphoric acid esters of | | |
| polyethoxylated tristyryl and distyrylphenol) | | |
| Xanthan gum, powder | 0.08% | Suspending aid |
| Blue pigment 15:3 | 0.50% | Colorant |
| Colemanite 75 micron | 57.50% | Nutrient |
| | 100.00% | |

| Example 11 | | |
|---|---|---|
| Water | 29.85% | Liqud carrier |
| Ethylene Glycol | 13.70% | Liqud carrier |
| Polyacrylic acid | 1.00% | Dispersant |
| polyoxyethylenated phosphates; 2,4,6-Tris(1- | 2.50% | Dispersant |
| phenylethyl)phenol polyoxyethylenated | | |
| phosphat; Phosphoric acid esters of | | |
| polyethoxylated tristyryl and distyrylphenol) | | |
| Xanthan gum, powder | 0.15% | Suspending aid |
| Copper (I) Oxide | 10.50% | Nutrient |
| Manganese (II) Carbonate | 19.50% | Nutrient |
| Maximo 910 | 22.50% | Nutrient |
| Blue Pigment 15:3 | 0.30% | Colorant |
| | 100.00% | |

| Example 12 | | |
|---|---|---|
| Ethylene glycol | 14.50% | Liquid carrier |
| Water | 16.95% | Liquid carrier |
| Xanthan gum, powder | 0.05% | Suspending aid |
| Polyarylphenyl ether phosphate | 1.75% | Dispersant |
| Polyacrylic acid | 1.75% | Dispersant |
| Colemanite | 30.00% | Nutrient |
| Zinc Oxide | 15.00% | Nutrient |
| Copper (I) Oxide | 7.00% | Nutrient |
| Manganese (II) Carbonate | 13.00% | Nutrient |
| | 100.00% | |

1. A fertilizer coating composition comprising a suspension comprising solid micronutrient particles suspended in liquid carrier, the liquid carrier comprising water-miscible organic liquid and optionally water.

2. A coating composition of claim 1 wherein the water-miscible organic liquid comprises one or more of: water-miscible solvent and surfactant.

3. A coating composition of claim 1 comprising at least 5 weight percent water-miscible organic liquid, based on total weight coating composition.

4. A coating composition of claim 1 wherein the liquid carrier comprises at least 10 weight percent water, based on total weight liquid carrier.

5. (canceled)

6. A coating composition of claim 1 wherein the organic solvent is selected from: a ketone, acetone, methyl-ethyl ketone (MEK), isophorone, dimethylformamide (DMF), dimethyl sulfoxide (DMSO), triethylphosphate, trimethylphosphate, sulfolane, dioxane, methanol, ethanol, isopropanol, dimethyl acetamide, ethylene glycol, propylene glycol, a glycol ether, a glycol ester, a glycerol, a polyglycol derivate, a lower alkyl lactate (e.g., ethyl, propyl and butyl lactate), an alkanolamine, an amino alcohol, a heterocyclic alcohol, hexamethylphosphoramide, a cyclic compound that contains an oxygen atom in a ring structure, and tetrahydrofuran (THF).

7. (canceled)

8. A coating composition of claim 1 comprising at least 30 weight percent suspended micronutrient particles, based on total weight of the suspension.

9. A coating composition of claim 1 comprising at least 40 weight percent suspended micronutrient particles, based on total weight of the suspension.

10. A coating composition of claim 1 comprising:
from 35 to 80 weight percent water-miscible liquid carrier, and
from 20 to 65 weight percent suspended solid micronutrient particles,
based on total weight suspension.

11. A coating composition of claim 1 wherein the micronutrient particles comprise zinc, boron, copper, iron, chlorine, molybdenum, manganese, or a combination thereof.

12. A coating composition of claim 1 wherein the water-soluble liquid carrier comprises less than 20 weight percent water-immiscible oil, based on total weight liquid carrier.

13. A coating composition of claim 1 that, upon un-agitated storage for at least 12 weeks at a temperature of 72 degrees Fahrenheit, does not exhibit visible sedimentation of solids out of the suspension.

14. A coating composition of claim 11 comprising a secondary nutrient selected from calcium, magnesium, sulfur, and a combination thereof.

15. A method of applying micronutrient to solid fertilizer particles, the method comprising:
providing a coating composition as recited at claim 1, and
applying the coating composition to solid fertilizer particles.

16. (canceled)

17. A method of claim 15 comprising applying the coating composition by flowing the coating composition through application equipment, and after applying, cleaning the coating composition from the equipment using water that does not contain a cleaning agent.

18. Fertilizer particles comprising a coating composition of claim 1.

19. A method of adding fertilizer to a field, the method comprising spreading fertilizer particles of claim 18 onto the field.

20. A coating composition of claim 1 comprising a suspending agent selected from fumed silica; magnesium aluminum silicate; a polymeric thickener (which may be water-miscible) such as hydroxymethyl cellulose (HMC), hydroxyethyl cellulose (HEC), hydroxypropyl cellulose (HPC), hydroxypropyl methylcellulose (HPMC), xanthan gum; and clay (including but not limited to bentonite).

21. A coating composition of claim 1 comprising biostimulant.

22. A coating composition of claim 1 comprising urease inhibitor.

23. A suspension of claim 1 comprising dicyandiamide.
